(19) United States
(12) Patent Application Publication
(10) Pub. No.: US 2016/0176041 A1
(43) Pub. Date: Jun. 23, 2016

(54) CURRENCY DELIVERY DEVICE

(71) Applicant: Gregory Green, Los Angeles, CA (US)

(72) Inventor: Gregory Green, Los Angeles, CA (US)

(21) Appl. No.: 14/575,233

(22) Filed: Dec. 18, 2014

(51) Int. Cl. B25J 1/04

(52) U.S. Cl. CPC B25J 1/04

(57) ABSTRACT

A currency delivery assembly for exchanging monetary currency between two individuals beyond arm's reach apart includes a rod gripped by a first person. A cup is coupled to the rod. The cup may contain monetary currency. The rod is manipulated by the first person to extend the cup toward a second person so the cup delivers the monetary currency to the second person. A clip is movably coupled to the cup to retain paper currency within the cup.

### BACKGROUND OF THE DISCLOSURE

### Field of the Disclosure

The disclosure relates to delivery devices and more particularly pertains to a new delivery device for exchanging monetary currency between two individuals beyond arm's reach apart.

### SUMMARY OF THE DISCLOSURE

An embodiment of the disclosure meets the needs presented above by generally comprising a rod gripped by a first person. A cup is coupled to the rod. The cup may contain monetary currency. The rod is manipulated by the first person to extend the cup toward a second person so the cup delivers the monetary currency to the second person. A clip is movably coupled to the cup to retain paper currency within the cup.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a currency delivery assembly according to an embodiment of the disclosure.

FIG. 2 is a top view of an embodiment of the disclosure.

FIG. 3 is a right side view of an embodiment of the disclosure.

FIG. 4 is a cross sectional view taken along line 4-4 of FIG. 2 of an embodiment of the disclosure.

FIG. 5 is a cross sectional view taken along line 5-5 of line 3 of an embodiment of the disclosure.

### DESCRIPTION OF THE PREFERRED EMBODIMENT

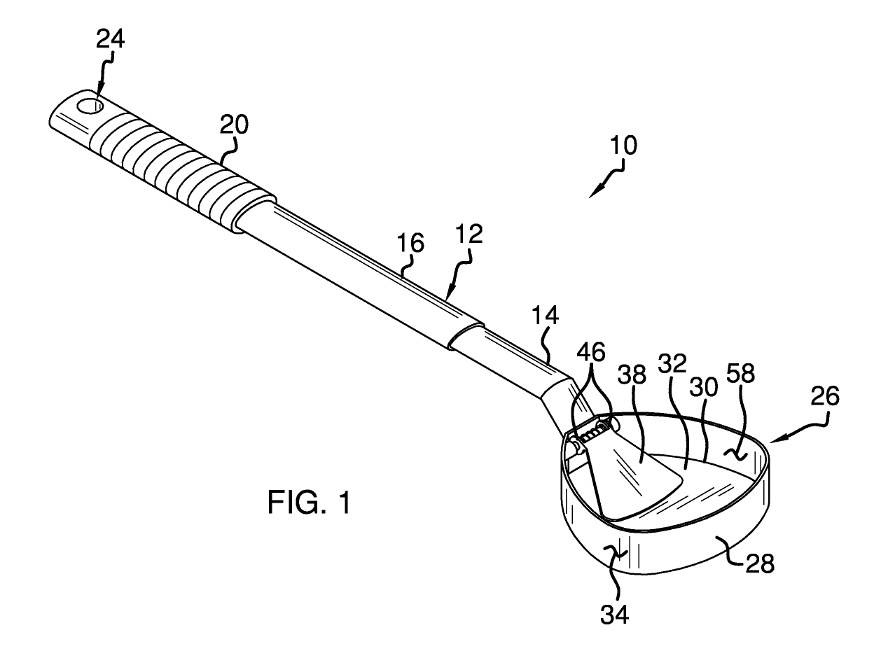

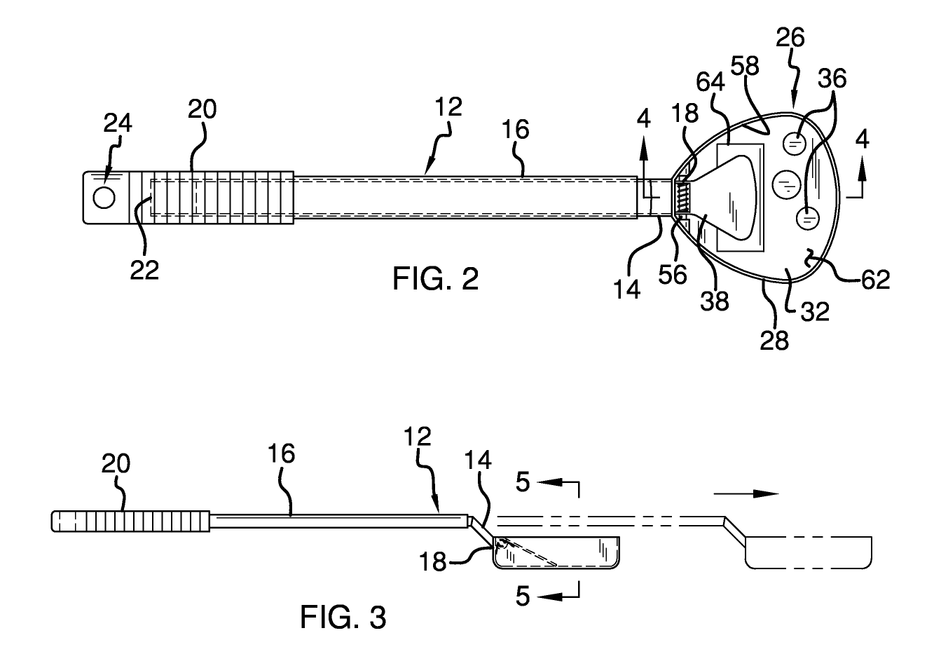

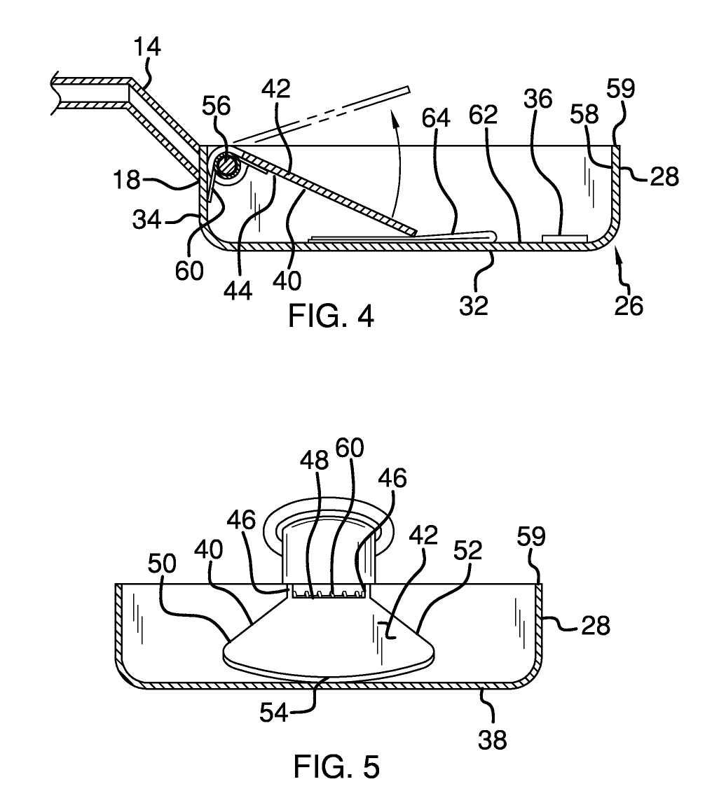

With reference now to the drawings, and in particular to FIGS. 1 through 5 thereof, a new delivery device embodying the principles and concepts of an embodiment of the disclosure and generally designated by the reference numeral 10 will be described.

As best illustrated in FIGS. 1 through 5, the currency delivery assembly 10 generally comprises a rod 12 that may be gripped by a first person. The rod 12 comprises a front section 14 slidably coupled to a back section 16 such that the rod 12 has a telescopically adjustable length. The front section 14 is bent proximate a distal end 18 of the front section 14 with respect to the back section 16. The distal end 18 is directed downwardly from the front section 14.

A grip 20 is provided. The grip 20 is coupled around the back section 16. The grip 20 extends forwardly from a back end 22 of the back section 16. The first person may grasp the grip 20. The grip 20 has an opening 24 extending therethrough. The opening 24 is positioned adjacent to the back end 22 of the back section 16. Additionally, the assembly 10 may be hanged by the opening 24.

A cup 26 is provided. The cup 26 has an outer wall 28 coupled to and extending upwardly from an outer edge 30 of a bottom wall 32 of the cup 26. An outer surface 34 of the outer wall 28 is coupled to the distal end 18 of the front section 14. The cup 26 may contain monetary currency 36. The rod 12 is manipulated by the first person to extend the cup 26 toward a second person. Thus, the cup 26 delivers the monetary currency 36 to the second person.

A clip 38 has an exterior edge 40 extending between a top surface 42 and a bottom surface 44 of the clip 38. The clip 38 has a pair of tabs 46 coupled to and extending rearwardly from a back side 48 of the exterior edge 40 of the clip 38. Each of the tabs 46 is positioned adjacent to an associated one of a first lateral side 50 and a second lateral side 52 of the exterior edge 40 of the clip 38. The back side 48 may have a width that is less than a width of a front side 54 the exterior edge 40 so the clip 38 has a trapezoidal shape.

A pin 56 extends through each of the tabs 46 and engages an inside surface 58 of the outer wall 28 proximate a top edge 59 of the outer wall 28 to hingedly couple the clip 38 to the cup 26. A spring biasing member 60 is coupled around the pin 56 to engage the bottom surface 44 of the clip 38 and the inside surface 58 of the outer wall 28. The spring biasing member 60 biases the clip 38 downwardly so the front side 54 of the exterior edge 40 abuts an upper surface 62 of the bottom wall 32 of the cup 26. The clip 38 retains paper currency 64 within the cup 26.

In use, the assembly 10 is utilized in a retail environment involving a drive thru window. The first person deposits the monetary currency 36 in the cup 26 to deliver the monetary currency 36 to the second person. The assembly 10 allows the monetary currency 36 to be comfortably exchanged over a large distance. Additionally, the clip 38 prevents the paper currency 64 from being blown out of the cup 26 by wind or other similar phenomenon.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. (canceled)

2. (canceled)

3. (canceled)

4. A currency delivery assembly comprising:
a rod configured to be gripped by a first person;
a cup coupled to said rod such that said cup is configured to contain monetary currency, wherein manipulation of said allows positioning of said cup proximate a second person positioned outside arm's reach of the first person wherein said cup is configured to deliver the monetary currency to the second person;
a clip movably coupled to said cup wherein said clip is configured to retain paper currency within said cup;
wherein said rod comprising a front section slidably coupled to a back section such that said rod has a telescopically adjustable length;
wherein said cup having an outer wall coupled to and extending upwardly from an outer edge of a bottom wall of said cup, an outer surface of said outer wall being coupled to a distal end of said front section with respect to said back section;
said clip having an exterior edge extending between a top surface and a bottom surface of said clip;
a pair of tabs coupled to and extending rearwardly from a back side of said exterior edge of said clip such that each of said tabs are positioned adjacent to an associated one of a first lateral side and a second lateral side of said exterior edge of said clip; and
a pin extending through each of said tabs and engaging an inside surface of said outer wall proximate a top edge of said outer wall such that said clip is hingedly coupled to said cup.

5. The assembly according to claim 4, further comprising a spring biasing member coupled around said pin such that said spring biasing member engages said bottom surface of said clip and an inside surface of said outer wall, said spring biasing member biasing said clip downwardly such that a front side of said exterior edge abuts an upper surface of said bottom wall of said cup.

6. A currency delivery assembly comprising:
a rod configured to be gripped by a first person, said rod comprising a front section slidably coupled to a back section such that said rod has a telescopically adjustable length;
a cup, said cup having an outer wall coupled to and extending upwardly from an outer edge of a bottom wall of said cup, an outer surface of said outer wall being coupled to a distal end of said front section with respect to said back section such that said cup is configured to contain monetary currency, said rod being manipulated by the first person such that said cup is extended toward a second person wherein said cup is configured to deliver the monetary currency to the second person;
a clip, said clip having an exterior edge extending between a top surface and a bottom surface of said clip, said clip having a pair of tabs coupled to and extending rearwardly from a back side of said exterior edge of said clip such that each of said tabs are positioned adjacent to an associated one of a first lateral side and a second lateral side of said exterior edge of said clip;
a pin extending through each of said tabs and engaging an inside surface of said outer wall proximate a top edge of said outer wall such that said clip is hingedly coupled to said cup; and
a spring biasing member coupled around said pin such that said spring biasing member engages said bottom surface of said clip and said inside surface of said outer wall, said spring biasing member biasing said clip downwardly such that a front side of said exterior edge abuts an upper surface of said bottom wall of said cup wherein said clip is configured to retain paper currency within said cup.
